(19) United States
(12) Patent Application Publication
(10) Pub. No.: US 2026/0065915 A1
(43) Pub. Date: Mar. 5, 2026

(54) AUDIO PROCESSING

(71) Applicant: Cirrus Logic International Semiconductor Ltd., Edinburgh (GB)

(72) Inventor: John P. LESSO, Edinburgh (GB)

(73) Assignee: Cirrus Logic International Semiconductor Ltd., Edinburgh (GB)

(21) Appl. No.: 19/237,519

(22) Filed: Jun. 13, 2025

Related U.S. Application Data
(60) Provisional application No. 63/689,945, filed on Sep. 3, 2024.

(51) Int. Cl. G10L 17/06

(52) U.S. Cl. CPC G10L 17/06

(57) ABSTRACT

A method of authenticating an origin of a primary audio signal, the method comprising: receiving the primary audio signal; receiving a reference audio signal from a reference microphone; extracting one or more characteristics from the reference audio signal and the primary audio signal; extracting channel properties of the reference audio signal; comparing the one or more characteristics of the reference audio signal to the one or more characteristics of the primary audio signal; comparing the channel properties of the reference audio signal to expected channel properties of the reference audio signal; and authenticating the origin of the primary audio signal based on the comparison between the one or more characteristics and the comparison of the channel properties of the reference audio signal to the expected channel properties.

### TECHNICAL FIELD

The present disclosure relates to methods of and apparatus for verifying and authenticating audio signal.

### BACKGROUND

Known speech recognition systems allow a user to control a device or system using spoken commands. Speech recognition systems are often used in conjunction with speaker recognition systems. A speaker recognition system can be used to verify the identity of a person who is speaking, and this can be used to control the operation of the speech recognition system.

When relying on speech and speaker recognition systems, it is advantageous to determine the authenticity of recorded audio. It is possible to verify that recorded audio was recorded at a specific microphone type by extracting a channel response from that recorded audio. However, such verification cannot be achieved without prior knowledge of the expected channel response of a microphone.

### SUMMARY

According to a first aspect of the disclosure, there is provided a method of authenticating an origin of a primary audio signal, the method comprising: receiving the primary audio signal; receiving a reference audio signal from a reference microphone; extracting one or more characteristics from the reference audio signal and the primary audio signal; extracting channel properties of the reference audio signal; comparing the one or more characteristics of the reference audio signal to the one or more characteristics of the primary audio signal; comparing the channel properties of the reference audio signal to expected channel properties of the reference audio signal; and authenticating the origin of the primary audio signal based on the comparison between the one or more characteristics and the comparison of the channel properties of the reference audio signal to the expected channel properties.

Authenticating the origin of the primary audio signal may comprise verifying that the primary audio signal originated from an unknown microphone.

The channel properties of the reference audio signal may comprise an impulse response or a frequency-domain response, or one or more noise properties of the channel.

The one or more characteristics may comprise a speech metric.

The speech metric may comprise one of: an articulation rate of speech in the reference and primary audio signals; a fundamental frequency; a distribution of fundamental frequencies.

The one or more characteristics may comprise a channel metric. The channel metric may comprise an impulse response or frequency response.

The method may further compromise: generating a first similarity score based on the comparison of the one or more characteristics of the reference audio signal to the one or more characteristics of the primary audio signal; and generating a second similarity score based on the comparison of the channel properties of the reference audio signal to the expected channel response.

The primary audio signal may be authenticated if the first similarity score exceeds a first similarity threshold and the second similarity score exceeds a second similarity threshold.

Authenticating the primary audio signal as originating from the first microphone may comprise: determining that a first correlation between the one or more characteristics of the reference and primary audio signals exceeds a first threshold; and determining that a second correlation between the channel properties of the reference audio signal and the expected channel properties exceeds a second threshold.

The method may further comprise tagging the primary audio signal with an authenticity result based on the first and second similarity scores.

Tagging the primary audio signal may comprise storing metadata associated with the primary audio signal, the metadata indicating an authenticity of the primary audio signal. The metadata may comprise an indication that the primary audio signal originated from the first microphone. The metadata may comprise an indication that the primary audio signal originated from a replay attack.

The method may further comprise, in response to the authentication, outputting the primary audio signal.

According to another aspect of the disclosure, there is provided circuitry for authenticating an origin of a primary audio signal, the method comprising: an first input for receiving the primary audio signal; a second input for receiving a reference signal from a reference microphone; and processing circuitry configured to: extract one or more characteristics from the reference audio signal and the primary audio signal; extract channel properties of the reference audio signal; compare the one or more characteristics of the reference audio signal to the one or more characteristics of the primary audio signal; compare the channel properties of the reference audio signal to expected channel properties of the reference audio signal; and authenticate the origin of the primary audio signal based on the comparison between the one or more characteristics and the comparison of the channel properties of the reference audio signal to the expected channel properties.

According to another aspect of the disclosure, there is provided a system comprising: the circuitry described above; the reference microphone; and an interface for connecting an unknown microphone, wherein authenticating the origin of the primary audio signal comprises authenticating that the primary audio signal was generated by the unknown microphone.

According to another aspect of the disclosure, there is provided an integrated circuit (IC) comprising the circuitry or the system described above.

According to another aspect of the disclosure, there is provided an electronic device comprising the circuitry or the system described above.

The electronic device may comprise one of a smartphone, a personal computer, a personal audio device, a games console, a home control system, a home entertainment system, and an in-vehicle entertainment system.

According to another aspect of the disclosure, there is provided an integrated circuit (IC), comprising: input circuitry for receiving a first audio signal and a second audio signal; and processing circuitry configured to: select one or more antispoofing processes for each of the first and second audio signals based on a source or one or more characteristics of the respective first and second audio signals; process the first and second audio signals using the respective selected one or more antispoofing processes to generate one or more verification results; and an output to output the one or more verification results.

The one or more verification results may provide an indication of whether speech present in one or both of the first and second audio signals is the result of live speech or a replay attack in which speech is replayed via a loudspeaker.

The source may comprise one or more of: a trusted microphone; an unknown microphone; a remote location, a respective one of the first and second audio signals transmitted from the remote location; and an ultrasonic microphone.

Where a source of the first audio signal is the trusted microphone and a source of the second audio signal is the unknown microphone, the selected antispoofing process may comprise: extracting the one or more characteristics from the first audio signal and the second audio signal; extracting channel properties of the second audio signal; comparing the one or more characteristics of the first audio signal to the one or more characteristics of the second audio signal; comparing the channel properties of the second audio signal to expected channel properties of the second audio signal; and generating the one or more verification results based on the comparison between the one or more characteristics and the comparison of the channel properties of the reference audio signal to the expected channel properties.

Where a source of the first audio signal is the ultrasonic microphone, the selected antispoofing process may comprise: analysing ultrasonic content of the first audio signal; and generating the one or more verification results based on the analysis.

Where a source of the first audio signal is the unknown microphone, the selected antispoofing process may comprise: analysing one or more speech metrics or channel metrics of the first audio signal; and generating the one or more verification results based on the analysis.

The processing circuitry may be configured to continuously monitor the first and second audio signals, the one or more verification results generated in real-time.

The processing circuitry may be configured to monitor the first and second audio signal in response to a trigger received at the IC.

The processing circuitry may be configured to combine the one or more verification results to obtain a combined verification result.

The IC may comprise: one or more additional inputs for receiving one or more additional audio signals. The processing circuitry may be configured to: select one or more antispoofing processes for each of the additional audio signals based on a respective source or characteristic of the additional audio signals; and process the one or more additional audio signals using the respective selected one or more antispoofing processes to generate the one or more verification results.

According to another aspect of the disclosure, there is provided an electronic device comprising the IC described above. The electronic device may comprise one of a smartphone, a personal computer, a personal audio device, a games console, a home control system, a home entertainment system, and an in-vehicle entertainment system.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 illustrates a device;

FIG. 2 is a schematic diagram of the device of FIG. 1;

FIG. 3 is a schematic diagram of the audio processing circuitry of FIG. 2;

FIG. 4 is a flow diagram of a process implemented by the audio processing circuitry of FIG. 3; and

FIG. 5 is a schematic diagram of an integrated circuit.

### DESCRIPTION OF EMBODIMENTS

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The methods described herein can be implemented in a wide range of devices and systems, for example a mobile telephone, an audio player, a video player, a mobile computing platform, a games device, a remote controller device, a toy, a machine, or a home automation controller or a domestic appliance. However, for ease of explanation of one embodiment, an illustrative example will be described, in which the implementation occurs in a personal computer (e.g. a laptop).

Embodiments of the present disclosure aim to address or at least ameliorate one or problems associated with verifying the authenticity of audio recorded by microphones having an unknown channel response or unknown channel properties. For example, when an external microphone is connected to a personal computer (PC), the PC may not have knowledge the channel response of that microphone.

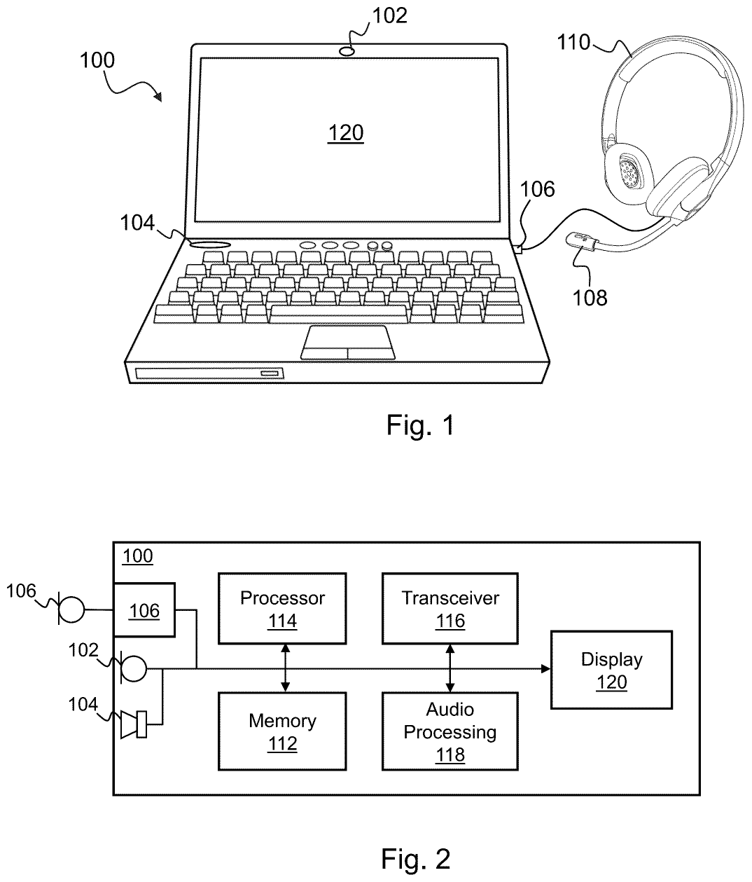

FIG. 1 illustrates an audio device 100, such as a personal computer (PC), having an internal microphone 102 for detecting ambient sounds and an output transducer 104, such as a loudspeaker for outputting audio. In normal use, the internal microphone 102 may be used for capturing speech of a user of the device 100 and the output transducer 104 may be used for playback of audio, such as media, speech, and the like. The internal microphone 102 may be integrated into the device 100 and may serve as a reference microphone for verifying the authenticity of recorded audio, as will be described in more detail below. The internal microphone 102 may be a secure microphone in that it cannot easily be tampered with and it within the control of the device 100.

The audio device 100 may comprise an interface 106 for connecting an external microphone 108. The interface 106 may be wired or wireless. For example, the interface 106 may comprise a 3.5 mm jack, a USB interface, or a Bluetooth connection. The external microphone 108 may be integrated into a headset 110 as shown in FIG. 1 or may be a standalone microphone. The content of audio recorded at the external microphone 108 may be substantially similar to that recorded by the internal microphone 102.

The device 100 may allow recording of audio using the internal microphone 102 and the external microphone 108 simultaneously. Using one or both of the microphones 102, 108 and the output transducer 104, the audio device 100 may be used for voice over internet protocol (VOIP) calls. In this example, output transducer 104 are integrated into the audio device 100. In other examples, the output transducer 104 may be a peripheral device, for example connected via the interface 106 or another wired or wireless interface.

FIG. 2 is a schematic diagram illustrating the form of the device 100. Specifically, FIG. 2 shows various interconnected components of the device 100. It will be appreciated that the device 100 will in practice contain many other components, but the following description is sufficient for an understanding of the present disclosure.

Thus, FIG. 2 shows the internal microphone 102, the output transducer 104, and the external microphone 108 connected via the interface 106 of the audio device 100, as described above.

The device 100 also comprise a memory 112, which may in practice be provided as a single component or as multiple components. The memory 112 is provided for storing data and program instructions.

The device 100 also comprises a processor 114, which again may in practice be provided as a single component or as multiple components. For example, one component of the processor 114 may be an applications processor of the device 100. The processor 114 may comprise a digital signal processor (DSP) for processing one or more audio signals.

The device 100 also comprises a transceiver 116, which is provided for allowing the device 100 to communicate with external networks. For example, the transceiver 116 may include circuitry for establishing an internet connection either over a Wi-Fi local area network or over a cellular network.

The device 100 also comprises audio processing (AP) circuitry 118, for performing operations on audio signals captured by the microphone 102 or to be output to the output transducer 104, as required. For example, the AP circuitry 118 may filter and/or amplify the audio signals or perform other signal processing operations. The AP circuitry 118 may comprise one or more digital to analog converters (DACs). The AP circuitry 118 may comprise one or more analog to digital converters (ADCs). The AP circuitry 118 may comprise one or more audio codecs. The audio processing circuitry 118 may comprise one or more digital signal processors (DSPs).

The device 100 may also comprise a display 120.

The output transducer 104 may be configured to output audio content at frequencies audible to a human ear, for example 20 Hz to 20 KHz. In addition, the output transducer 104 may be configured to output audio content at ultrasonic frequencies, for example above frequencies audible to a human ear or above of 20 KHz.

The device 100 may be provided with voice biometric functionality, and with control functionality. For example, the device 100 may be able to perform various functions in response to spoken commands from an enrolled user. The biometric functionality is able to distinguish between spoken commands from the enrolled user, and the same commands when spoken by a different person. Thus, certain embodiments of the invention relate to operation of a PC (e.g. tablet, laptop or desktop) or another portable electronic device with some sort of voice operability, for example a smartphone, a games console, a home control system, a home entertainment system, an in-vehicle entertainment system, a domestic appliance, or the like, in which the voice biometric functionality is performed in the device that is intended to carry out the spoken command. Certain other embodiments relate to systems in which the voice biometric functionality is performed on a PC or other device, which then transmits the commands to a separate device if the voice biometric functionality is able to confirm that the speaker was the enrolled user.

In some embodiments, while voice biometric functionality is performed on the device 100 or other device that is located close to the user, the spoken commands are transmitted using the transceiver 116 to a remote speech recognition system (not shown), which determines the meaning of the spoken commands. For example, the speech recognition system may be located on one or more remote server in a cloud computing environment. Signals based on the meaning of the spoken commands are then returned to the device 100 or another local device. In other embodiments, the speech recognition system is also located on the device 100.

As mentioned above, it is possible to verify that audio received by the device 100 was recorded by a microphone whose characteristics are known. For example, the characteristics of the internal microphone 102 of the device 100 may be known. By extracting a channel response from audio recorded by the internal microphone 102 and comparing that channel response to an expected channel response for the internal microphone 102, a determination may be made as to whether the audio was actually recorded by the internal microphone 102. Examples of such techniques are described in U.S. Pat. Nos. 11,769,510 and 11,024,317, the contents of which are hereby incorporated by reference in their entirety.

In some use cases, the expected channel response for a microphone may be unknown. For example, the interface 106 of the device 100 may allow any number of different types of external microphone 108 to be connected. For example, the external microphone 108 may be incorporated into a headset, a camera, or an external microphone accessory. Thus, characteristics of the external microphone 108 may be unknown. 102 another example the channel response associated with the internal microphone 102 may be unknown, for example if the microphone 106 has been replaced after manufacture of the device 100 (e.g. due to a repair) and the device 100 or a user does not have knowledge of the substitute microphone.

To ascertain one or more characteristics of an unknown microphone, such as the external microphone 108 it is proposed to record audio from both an unknown microphone and a known reference microphone. For the purpose of the following description, the internal microphone 102 is considered a known reference microphone and the external microphone 108 is deemed an unknown microphone.

Recorded audio can be verified as being captured by the external microphone 108 if a) that recorded audio matches audio captured by the internal microphone 102, and b) the channel response extracted from audio captured by the internal microphone 102 matches an expected channel response. For the purpose of the following description, the processing of the captured audio signals is implemented by the audio processing AP circuitry 118. It will be appreciated, however, that such processing may be implemented elsewhere in the device 100 or by a host device, e.g. in the cloud.

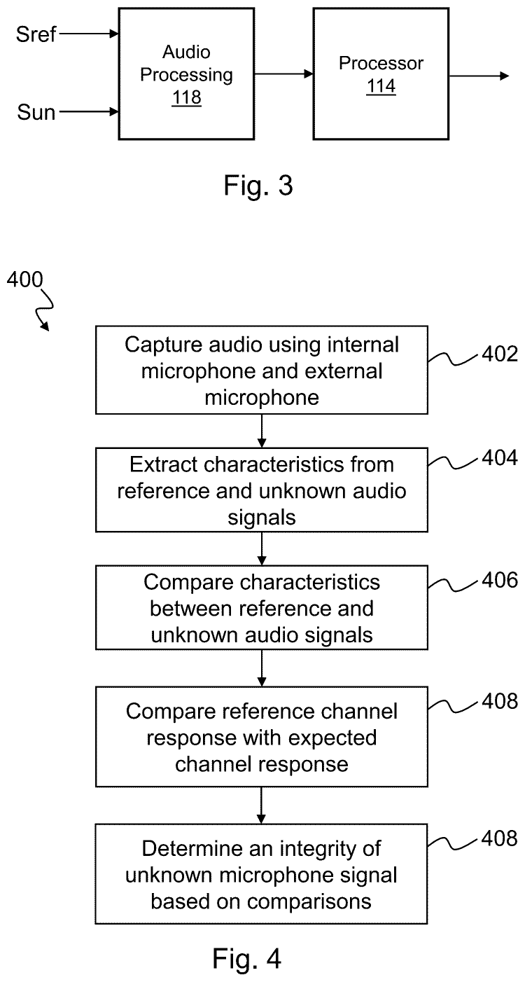

FIG. 3 is a schematic diagram of an example signal chain implemented in the device 100 for validating the integrity of a primary audio signal Sun, in this case received from the external (unknown) microphone 108.

The AP circuitry 118 is configured to receive a reference audio signal Sref from the internal (known reference) microphone 102 and the primary audio signal Sun from the external (unknown) microphone 108. The reference audio signal Sref is that which is generated by the internal microphone 102 whose characteristics are known. The primary audio signal Sun is that which is generated by the external microphone 108 whose characteristics are unknown. The reference and primary audio signals Sref, Sun may be stored in memory 112 of the device for analysis or may be analysed in real time, e.g. by the AP circuitry 118.

The AP circuitry 118 is configured to compare the reference and primary signals Sref, Sun. To do so, the AP circuitry 118 may be configured to directly compare the reference and primary audio signals Sref, Sun. Additionally, or alternatively, the AP circuitry 118 may be configured to compare one or more characteristics of the reference and primary audio signals Sref, Sun.

To compare characteristics of the reference and primary audio signals Sref, Sun, the AP circuitry 118 may be configured extract one or more characteristics from each of the reference and primary audio signals Sref, Sun. For example, the AP circuitry 118 may be configured to extract one or more speech metrics and/or channel metrics from the reference and primary audio signals Sref, Sun. Example speech metrics include one or more articulation parameters such as articulation rate, a fundamental frequency F0, or a distribution of fundamental frequencies F0. Example, channel metrics include an impulse response of the respective audio signals.

The AP circuitry 118 may then be configured to compare one or more corresponding metrics extracted from each of the reference audio signal Sref and the primary audio signal Sun. For example, a fundamental frequency F0 of the reference audio signal Sref may be compared to a fundamental frequency F0 of the primary audio signal Sun. If the fundamental frequency F0 of the reference audio signal Sref is within a threshold range of the fundamental frequency F0 of the primary audio signal Sun, then the AP circuitry 118 may determine that the content of the reference and primary audio signals Sref, Sun is similar, which may indicate that the primary audio signal Sun was captured by the external microphone 108. In another example, an impulse response or a frequency response of the reference audio signal Sref may be compared to an impulse response or a frequency response of the primary audio signal Sun. If the impulse or frequency response of the reference audio signal Sref is within a threshold range of the impulse or frequency response of the primary audio signal Sun, then the AP circuitry 118 may determine that the content of the reference and primary audio signals Sref, Sun is similar, which may indicate that the primary audio signal Sun was captured by the external microphone 108.

In addition to comparing the reference and primary audio signals Sref, Sun, the AP circuitry 118 may be configured to measure a channel response of the reference audio signal Sref and compare the measured channel response to an expected channel response. The expected channel response may be stored in the memory 112. A match between the measured channel response of the reference audio signal Sref and the stored expected channel response may indicate that the reference audio signal Sref was captured by the internal microphone 102. This may in turn verify the integrity of the reference audio signal Sref. By verifying that the reference audio signal Sref was generated by the internal microphone 102, and that the contents of the reference audio signal Sref correlates with the contents of the primary audio signal Sun, the integrity of the primary audio signal Sun can be verified. Such verification can be performed without knowledge of the characteristics of the external microphone 108.

Thus, the present disclosure provides a method for verifying the integrity of audio signals received and processed by the device 100, thereby providing a robust defence to man in the middle attacks and related security breaches.

FIG. 4 is a flow diagram of an example process 400 for verifying the integrity of recorded audio according to embodiments of the present disclosure.

At step 402, sound is captured by the internal microphone 102 and the external microphone 108 and converted into respective reference and primary audio signals Sref, Sun which are provided to the AP circuitry 118. The reference and primary audio signals may be stored in memory 112 of the device for analysis or may be analysed in real time by the processor 114 and/or the AP circuitry 118. Additionally, or alternatively, analysis and/or processing of the reference and primary audio signals Sref, Sun may be performed on a host device (not shown), for example in the cloud. In such circumstances, the reference and primary audio signals Sref, Sun may be transmitted using the transceiver 116 to the host device.

At step 404, the reference and primary audio signals Sref, Sun may undergo processing to extract one or more respective characteristics. For example, the device 100 may be configured to extract one or more speech metrics and/or channel metrics from the reference and primary audio signals Sref, Sun. Example speech metrics include a fundamental frequency F0 of the respective audio signals. Example, channel metrics include an impulse response of the respective audio signals.

At step 406, the AP circuitry 118 compares the extracted one or more respective characteristics for the reference and primary audio signals Sref, Sun. The AP circuitry 118 may generate similarity metric which may indicate a level of correlation between the reference and primary audio signals Sref, Sun.

At step 408, the AP circuitry 118 may compare a channel response of the reference audio signal Sref, such as an impulse response, extracted at step 404 to an expected response of the reference audio signal Sref. The AP circuitry 118 may generate a similarity metric which may indicate a level of correlation between the channel response measured in the reference audio signal Sref and the expected response.

At step 410, based on the comparisons at step 406, 408, the AP circuitry 118 may make a determination as to the integrity of the primary audio signal Sun.

Once a determination has been made as to the integrity of the primary audio signal Sun, that signal may then be tagged, or associated metadate updated, to reflect that that the primary audio signal Sun is from a trusted source (and not the product of a malicious injection attack) or that the primary audio signal Sun is may not be from a trusted source (and may therefore be the product of a malicious injection or man in the middle attack). Such tags or meta data may be stored and/or transmitted by with the primary audio signal Sun. For example, the primary audio signal Sun may be transmitted via the transceiver 116 to a third party, such as a remote or host system or remote user. Examples of such a remote system include a remote call centre, an online authentication system associated with a banking service etc, and a third party or application engaged in a secure VOIP call with a user of the device 100.

The AP circuitry 118 may be further configured to determine whether the primary audio signal Sun contains speech or sound generated by a live human speaker (e.g. proximate the external microphone 108), or whether the primary audio signal Sun contains speech that is generated as part of a replay attack. To make such a determination, the AP circuitry 118 may be configured to analyse the reference audio signal Sref and/or the primary audio signal Sun to detect characteristics or markers indicative of audio generated by a loudspeaker proximate the device 100. Such techniques are described in U.S. Pat. Nos. 11,631,402 and 11,051,117, the contents of which is hereby incorporated by reference in their entirety.

If analysis of the reference and/or primary audio signals Sref, Sun indicates that the monitored speech is not from a live (human) speaker or is the result of audio replayed through a loudspeaker, the AP circuitry 118 may be configured to tag the reference audio signal Sref and/or the primary audio signal Sun (or updated meta data) accordingly, as described above. Additionally, or alternatively, the AP circuitry 118 may cause a warning or flag to be displayed to a user, for example on the display 120. Additionally, or alternatively, operation of the device 100 may be restricted, for example by preventing access to certain (e.g. sensitive) information on the device 100.

As described above, the primary audio signal Sun or the reference audio signal Sun may be transmitted to a third party, e.g. via the transceiver 116. The reference and/or primary audio signals Sref, Sun may be updated with metadata to indicate that the audio did not come from a live speaker. The metadata may be accessible by a remote user or system to indicate to that user or system that the audio is not from a live speaker (and therefore may be the result of a malicious actor).

Whilst the device in FIG. 2 comprises a single internal microphone 102, embodiments are not so limited. For example, the device 100 may comprise one or more additional microphones. Additionally, or alternatively, more than one microphone may be connected to the device 100 via the interface 106. Where multiple microphones are provided, the AP circuitry 118 may be configured to monitor audio signals generated from each microphone. An advantage of monitoring multiple reference microphones (i.e. microphones whose characteristics are known) is that such audio signals can be used to determine if large or multi-channel speakers have been used in replay attacks. Such techniques are described in U.S. Pat. Nos. 10,839,808 and 11,276,409, the contents of which are hereby incorporated by reference in their entirety.

Functionality of the AP circuitry 118, such as for verifying the origin of audio signals as described above, may be integrated into a dedicated antispoofing integrated circuit (IC). Such an antispoofing IC may be configured to receive multiple audio channels and apply selected antispoofing processes based on the source of the audio or in response to specific triggers. The antispoofing IC 500 may generate a verification result that can be output to a user (e.g. of the device 100) or transmitted to a remote system, for example via the transceiver 116. Such an antispoofing IC may be integrated into a device, such as the device 100. The IC may be configured to received audio signals stored in memory, such as the memory 112.

For example, if an audio signal has been recorded using a wide-bandwidth microphone capable of capturing ultrasonic frequencies, the antispoofing IC may analyse the signal to determine the presence of non-human audio, such as synthesized audio or audio generated by a loudspeaker proximate the microphone.

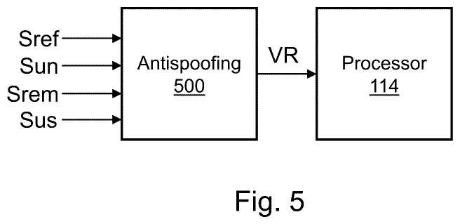

FIG. 5 is a schematic diagram of an example antispoofing IC 500 according to embodiments of the present disclosure.

The antispoofing IC 500 may be provided as part of the device 100. For example, the antispoofing IC 500 may be integrated as part of the AP circuitry 118. The antispoofing IC 500 may be in communication with the processor 114 when the IC 500 is integrated into the device 100.

The antispoofing IC 500 may be configured to receive audio signals from multiple sources. In the example shown, the IC 500 is configured to receive the reference audio signal Sref from the internal microphone 102 and the primary audio signal Sun from the external microphone 108. In addition, the IC 500 may be configured to receive an ultrasonic signal Sus, for example from an ultrasonic microphone which may be integrated into the device 100. In addition, the IC 500 may be configured to receive a remote audio signal Srem, for example, from a remote location. The remote audio signal Srem may be transmitted to the device 100 via the transceiver 116 when the antispoofing IC 500 is integrated into the device 100. The remove audio signal Srem may be transmitted to the device 100 as part of a VOIP call.

The antispoofing IC 500 is configured to select an antispoofing process to apply based on the source of audio received at the IC 500.

For example, if the audio source comprises a device-based microphone, such as the internal microphone 102 of the device 100, the antispoofing IC 500 may select processes that can rely on a secure hardware connection to the microphone.

For example, antispoofing processes may be selected based on the capabilities of the audio source, such as a bandwidth of the audio source (e.g. microphone). For example, if the audio source is a wide-bandwidth microphone capable or recording ultrasonic frequencies, the antispoofing IC 500 may be configured to select antispoofing processes adapted to determine ultrasonic content of audio to identify whether the audio is the result of live speech at the audio source or is the subject of a replay attack (replay of speech by a loudspeaker). Such processes are known in the art and so will not be described in more detail here. An example of such a process is described in U.S. Pat. No. 12,288,553, the contents of which is hereby incorporated by reference in its entirety.

In another example, if the audio source comprises an audio accessory coupled to a device, such as the external microphone 108 coupled to the device 100, the integrity of the audio source itself cannot be guaranteed. In such cases, the antispoofing IC 500 may be configured to select antispoofing processes which rely on the content of the audio signal received from that audio source. Examples of such processes include the analysis of speech metrics (e.g. articulation rate, fundamental frequency, discontinuities in speech level etc.) to determine whether the audio is the result of live speech at the audio source or is the subject of a replay attack (replay of speech by a loudspeaker).

In another example, if the audio source is transmitted from a remote device, such as is the case for the remote audio signal Srem, then the antispoofing IC may select to use antispoofing processes may be selected or adapted to take into account potential compression or artefacts which may be present due to the transfer of the remote audio signal Srem via the internet or other network.

Using the selected antispoofing process or processes the antispoofing IC 500 may perform an antispoofing procedure and output one or more verification results VR. Such verification results VR may indicate whether an audio signal received at the antispoofing IC 500 is the result of live speech or replayed speech from a loudspeaker.

The antispoofing IC 500 may be configured to monitor several audio streams, such as those described above, in parallel. The antispoofing IC 500 may output a verification result VR for each of monitored audio streams. Additionally, or alternatively, the antispoofing IC 500 may be configured to fuse or combine individual verification results VR from different streams to provide a combined verification result.

In any case, verification results VR or combined verification results may be output to the processor 114 or to a user of the device 100, for example, via the display 120. Additionally, or alternatively, verification results VR may be appended to recorded audio (as tags or metadata) for transmittal, for example to a remote location.

The antispoofing IC 500 may be configured to continuously monitor audio to generate continuous verification results VR. Alternatively, the antispoofing IC 500 may be triggered to analyse audio in response to a trigger. The trigger may be received, for example, from a user, a software application, or from a remote user or verification system. In such a case, the antispoofing IC 500 may perform the above-described antispoofing process based on the available audio channels (e.g. Sref, Sun, Srem, Sus). The antispoofing IC 500 may be configured to generate a combined verification result in response to the trigger.

The antispoofing IC 500 may be configured to communicate verification result(s) VR to the processor 114 which may then communicate those verification result(s) VR to a user, e.g. via the display 120 and/or communicate those verification result(s) VR to a remote device, e.g. via the transceiver 116.

Thus, embodiments of the present disclosure offer a robust solution for verifying the origin of recorded audio and detecting spoofing attacks, enhancing the security of voice-based systems and remote authentication processes. Through the use of a reference microphone, advanced signal processing, and integrated antispoofing circuitry, embodiments of the present disclosure enable recorded audio to be trusted and authenticated with higher confidence.

The provision of a dedicated antispoofing IC allows for appropriate antispoofing tests to be applied to received audio based on the qualities and properties of the particular audio source being monitored.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote-control device, a home automation controller, or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A method of authenticating an origin of a primary audio signal, the method comprising:
receiving the primary audio signal;
receiving a reference audio signal from a reference microphone;
extracting one or more characteristics from the reference audio signal and the primary audio signal;
extracting channel properties of the reference audio signal;
comparing the one or more characteristics of the reference audio signal to the one or more characteristics of the primary audio signal;
comparing the channel properties of the reference audio signal to expected channel properties of the reference audio signal; and
authenticating the origin of the primary audio signal based on the comparison between the one or more characteristics and the comparison of the channel properties of the reference audio signal to the expected channel properties.

2. The method of claim 1, wherein authenticating the origin of the primary audio signal comprises verifying that the primary audio signal originated from an unknown microphone.

3. The method of claim 1, wherein the channel properties of the reference audio signal comprises an impulse response or a frequency-domain response.

4. The method of claim 1, wherein the one or more characteristics comprises a speech metric.

5. The method of claim 4, wherein the speech metric comprises one of:
an articulation rate of speech in the reference and primary audio signals;
a fundamental frequency;
a distribution of fundamental frequencies.

6. The method of claim 1, wherein the one or more characteristics comprises a channel metric.

7. The method of claim 5, wherein the channel metric comprises an impulse response or frequency response.

8. The method of claim 1, further comprising:
generating a first similarity score based on the comparison of the one or more characteristics of the reference audio signal to the one or more characteristics of the primary audio signal;
generating a second similarity score based on the comparison of the channel properties of the reference audio signal to the expected channel response.

9. The method of claim 8, wherein the primary audio signal is authenticated if the first similarity score exceeds a first similarity threshold and the second similarity score exceeds a second similarity threshold.

10. The method of claim 1, wherein authenticating the primary audio signal as originating from the first microphone comprises:
determining that a first correlation between the one or more characteristics of the reference and primary audio signals exceeds a first threshold;
determining that a second correlation between the channel properties of the reference audio signal and the expected channel properties exceeds a second threshold.

11. The method of claim 1, further comprising:
tagging the primary audio signal with an authenticity result based on the first and second similarity scores.

12. The method of claim 1, wherein tagging the primary audio signal comprises storing metadata associated with the primary audio signal, the metadata indicating an authenticity of the primary audio signal.

13. The method of claim 12, wherein the metadata comprises an indication that the primary audio signal originated from the first microphone.

14. The method of claim 12, wherein the metadata comprises an indication that the primary audio signal originated from a replay attack.

15. The method of claim 1, further comprising, in response to the authentication, outputting the primary audio signal.

16. Circuitry for authenticating an origin of a primary audio signal, the method comprising:
an first input for receiving the primary audio signal;
a second input for receiving a reference signal from a reference microphone; and
processing circuitry configured to:
extract one or more characteristics from the reference audio signal and the primary audio signal;
extract channel properties of the reference audio signal;
compare the one or more characteristics of the reference audio signal to the one or more characteristics of the primary audio signal;
compare the channel properties of the reference audio signal to expected channel properties of the reference audio signal; and
authenticate the origin of the primary audio signal based on the comparison between the one or more characteristics and the comparison of the channel properties of the reference audio signal to the expected channel properties.

17. A system comprising:
the circuitry of claim 16;
the reference microphone; and
an interface for connecting an unknown microphone,
wherein authenticating the origin of the primary audio signal comprises authenticating that the primary audio signal was generated by the unknown microphone.

18. An integrated circuit (IC) comprising the circuitry of claim 16.

19. An electronic device comprising the circuitry of claim 16, wherein the electronic device comprises one of a smartphone, a personal computer, a personal audio device, a games console, a home control system, a home entertainment system, and an in-vehicle entertainment system.

20.-32. (canceled)
